(19) United States
(12) Patent Application Publication
(10) Pub. No.: US 2016/0241053 A1
(43) Pub. Date: Aug. 18, 2016

(54) DOWNHOLE BATTERY CONTROL AND MONITORING ASSEMBLY

(71) Applicant: REME, L.L.C., CONROE, TX (US)

(72) Inventors: ABRAHAM ERDOS, HOUSTON, TX (US); DAVID ERDOS, HOUSTON, TX (US); KENNETH MILLER, HOUSTON, TX (US); BRAD MUNOZ, HOUSTON, TX (US); JOSEPH WRIGHT, SPRING, TX (US); JOSHUA CARTER, CONROE, TX (US); JAMES MATHIESON, CONROE, TX (US)

(73) Assignee: REME, L.L.C., CONROE, TX (US)

(21) Appl. No.: 14/991,634

(22) Filed: Jan. 8, 2016

Related U.S. Application Data
(60) Provisional application No. 62/101,801, filed on Jan. 9, 2015.

(51) Int. Cl. H02J 7/00

(52) U.S. Cl. CPC H02J 7/0013

(57) ABSTRACT

An improved downhole battery control, monitoring, and management system is described wherein battery pack parameters can be measured and used to determine optimal and efficient battery usage scenarios for a downhole measurement system. A battery local controller network is configured and used to monitor, control, and manage the batteries deployed in a downhole measurement system. Battery parameters such as voltage, power usage, energy consumption, uptime, temperature, current, and other parameters may be monitored and/or communicated on the battery local controller network and used to make management decisions about which batteries to utilize in a given time period.

### BACKGROUND

1. Field of the Invention

The present invention relates to downhole measurement assemblies.

2. Description of the Related Art

Measurement-While-Drilling (“MWD”) Assemblies and Logging-While-Drilling (“LWD”) Assemblies are designed to perform measurement and data acquisition of subsurface geological parameters before, during, and after drilling operations, though most systems are typically deployed during drilling. In LWD systems the parameters of interest are typically stored during the operation and later retrieved for post processing after the tool is removed from the well. In MWD systems, the measured data is often communicated to the surface during a drilling operation for real time or near-real-time analysis. In both MWD and LWD systems, the remote sensor system is often powered through battery packs deployed downhole with the measurement system. In typical configurations of both MWD and LWD systems, multiple battery packs are deployed to ensure adequate power is available throughout the operation.

MWD and LWD systems have been used in drilling operations for some time. In downhole drilling it is useful to take measurements to facilitate the identification of sub-surface rock formations or take measurements to identify other useful parameters of downhole formations or downhole equipment. Downhole measurement assemblies and methods can be customized to suit a particular downhole environment. This can be useful when, for example, a drilling rig can be optimized to be effective for a particular type of rock formation and characteristics of the rock formation change as the wellbore extends deeper beneath the surface. It would thus be useful to configure downhole measurement assemblies that can adapt to a changing downhole environment. Measurement assemblies can also experience harsh vibrations and temperatures as well as other environmental conditions during the installation process, when taking measurements, while sitting downhole, and also during retrieval. Over time drilling operations have seen drilling to greater depths, causing measurement assemblies to experience increasingly harsher environments. In addition, many of the measurement sensors, battery packs, and other components can be particularly sensitive and malfunction in response to vibration, harsh temperatures, and other environmental factors. Vibration factors can be particularly problematic for measurement sensors used in downhole radiation measurement assemblies. These factors and others continue to create the need for more advanced and reliable downhole measurement assemblies.

It would be desirable to have measurement assemblies and measurement assembly components that include greater resilience to vibration, harsh temperatures, and other environmental factors that are present downhole. Further, it would be desirable to provide increased meantime between failures of measurement assemblies installed downhole and increased uptime generally. This would allow greater drilling time, increased measurement time, and decreased time spent installing, retrieving, and servicing radiation measurement assemblies. One way to help facilitate this is through the precise control, monitoring, and management of measurement assembly components. In particular, it would be desirable to control, monitor, and manage the battery packs that are deployed with MWD and LWD systems to efficiently use and deplete the stored energy of the battery packs and also monitor for potential problems with battery packs so downtime can be avoided. It would further be desirable to decrease the time committed to servicing measurement assemblies due to anticipated battery depletion when battery life still remains. For example, it would be desirable to track the depletion of each battery and/or battery pack in a downhole assembly and to optimize the depletion of each battery and/or battery pack such that battery related service intervals are extended. This would also be beneficial both in terms of cost savings for the batteries themselves and in terms of battery-related servicing costs, including costs related to downtime of a well.

### SUMMARY OF THE INVENTION

The present invention provides an improved battery based control, monitoring, and management system and assembly for use and integration with downhole tools. In particular, downhole measurement assemblies having particular reliance on battery power to facilitate downhole measurement gathering and logging will benefit from aspects of the invention.

The following invention presents a novel application of control, monitoring, and management of battery packs in downhole tools. A battery pack is configured with a local controller, networking assembly, sensors, and a monitoring and logging sub-system. The local controller can be configured to interface with a global network of the tool string. Battery status parameters can be queried over the global network including, but not limited to, battery voltage, percent power used or remaining, temperature, or battery unique ID. The local battery controller can also be prompted to switch battery packs onto or off of a battery bus as necessary. Additionally, the local controller can be used to record battery statistics for additional processing, these statistics may include, battery voltage over time, battery temperature over time, percent power used or remaining over time, or other useful battery health and usage values.

### BRIEF DESCRIPTION OF THE DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 depicts a block diagram schematic of a typical MWD tool configuration.

FIG. 2 depicts a block diagram schematic of an embodiment of the downhole battery control and monitoring system of the present invention.

FIG. 3 is a schematic view of the downhole battery control and monitoring system and assembly described in FIG. 2.

FIG. 4 depicts a flow chart of a job start sequence for an embodiment of the downhole battery control and monitoring system and assembly.

FIG. 5 depicts a flow chart of a smart power down sequence for an embodiment of the downhole battery control and monitoring system and assembly.

FIG. 6 depicts a flow chart of a coordination algorithm for an embodiment of the downhole battery control and monitoring system and assembly.

FIG. 7 depicts a flow chart of a monitoring algorithm for an embodiment of the downhole battery control and monitoring system and assembly.

FIG. 8 depicts a battery “roll call” configuration for an embodiment of the downhole battery control and monitoring system and assembly.

FIG. 9A depicts a first side of a circuit board layout embodiment for the downhole battery control and monitoring system and assembly.

FIG. 9B depicts a second side of a circuit board layout embodiment for the downhole battery control and monitoring system and assembly.

### DETAILED DESCRIPTION

The present invention provides an improved battery based control, monitoring, and management system and assembly for use and integration with downhole tools. In particular, downhole measurement assemblies having particular reliance on battery power to facilitate downhole measurement gathering and logging will benefit from aspects of the invention.

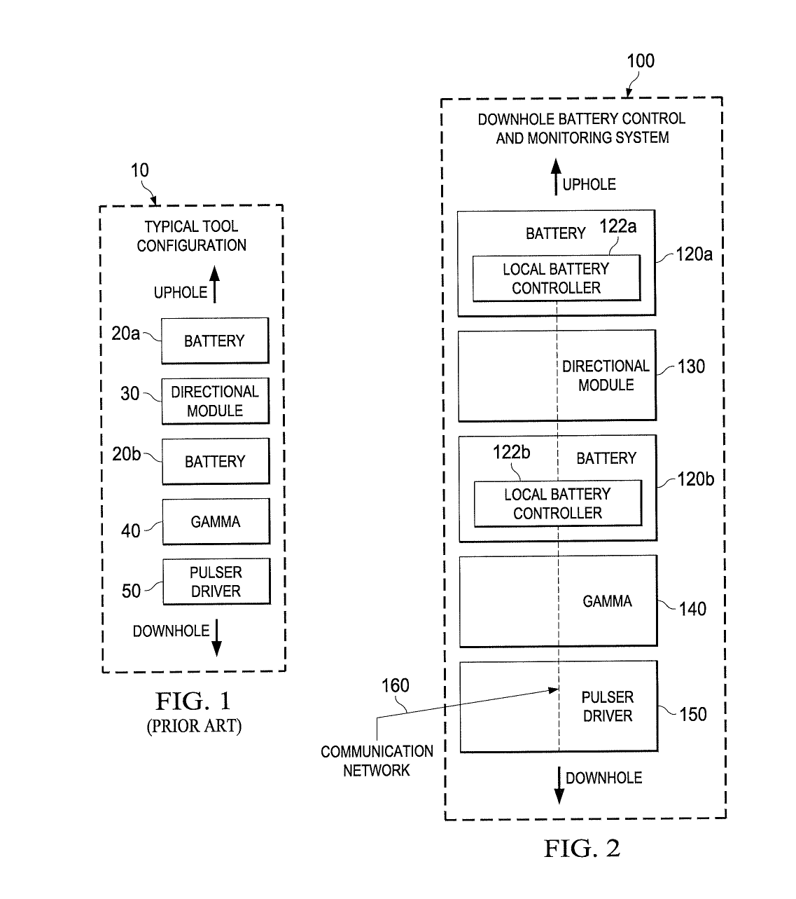

FIG. 1 shows a typical battery powered downhole measurement tool 10. The tool 10 is typically deployed by lowering it into a well through the inner diameter of the drill pipe string. The tool in this example consists of multiple battery packs, 20a and 20b respectively, a directional module consisting of a processing module and an orientation module 30, a gamma controller and measurement module 40, a pulser driver module 50, and an MWD communication system for communication with the surface (not shown). In an embodiment, the ordering of the various components as deployed downhole may vary. For example, the battery packs can be deployed in sequence, and one or multiple battery packs may be deployed depending on the desired configuration.

FIG. 2 shows a downhole battery control, monitoring, and management system and assembly embodiment 100. The illustrated and described embodiment is configured in a typical MWD system which typically is setup to run two battery packs, 120a and 120b respectively, however the invention is applicable and may be configured for a system having a larger number of battery packs. The tool in this example consists of multiple control and monitoring capable battery packs, 120a and 120b, a directional module that is typically configured with a processing module and an orientation module 130, a gamma controller and measurement module 140, a pulser driver module 150, and an MWD communication system for communication with the surface 160. The tool also includes local battery controller assemblies 122a and 122b.

In an embodiment, the downhole battery control, monitoring, and management system can consist of two or more battery packs, each battery pack being configured with a local controller, networking assembly, sensors, and a monitoring and logging sub-system. A local controller can be configured to interface with a global network of the tool string. Battery status parameters can be queried over the global network, including but not limited to parameters such as, battery voltage, percent energy used or remaining, temperature, and/or battery unique ID. The local battery controller can also be prompted to switch battery packs on or off of a battery bus as necessary. Additionally, the local controller can be used to record battery statistics for additional processing, these statistics may include, battery voltage over time, battery temperature over time, percent energy used or remaining over time, or other useful battery health and usage values. A standard parameter logging interval may be set up to record these parameters, for example, it may be desirable to log these parameter values at one second intervals. Memory availability may also factor in to the setup of a desired logging configuration for a particular job.

In an embodiment, the local battery controllers can include a networking component that allows the controllers to connect over a CAN or other similar network interfaces. For example, other multi-node serial buses can be configured such as RS-485 or qMIX bus. In this configuration, the batteries could, for example, communicate their remaining energy levels to the other battery packs deployed as part of the downhole measurement system. In the described and illustrated configuration, if the primary battery pack were to fall below a pre-determined threshold of remaining energy, the primary battery pack could communicate over the network to a backup battery pack, and ask the backup battery pack to place its battery onto the battery bus. In an embodiment, the backup battery pack can be configured to confirm the communication and confirm when the battery has provided power on the battery bus so that the primary battery pack can turn off the battery bus connection to its battery. Additionally, if a battery pack on the communication network determined that its battery was nearing or above a pre-determined temperature threshold, it could similarly request another battery pack to place its battery on the battery bus so that it can switch off the connection to the battery bus and cool down. In this way, the battery control, monitoring, and measurement system can be configured to where it is not limited to sequential depletion of each configured battery one by one. For applications which have high power requirements, the battery controllers may coordinate multiple battery packs to switch onto the battery bus at the same time, allowing the current draw of each battery pack to stay in a range more optimal to extending the life of the battery pack. In an embodiment, the batteries can switch back and forth between which battery is powering the measurement system in an extremely optimal and efficient manner. For example, in a particular system and a particular environment, if deployed battery packs were quickly rising to inefficient temperatures when in use, other battery packs can take over while the former battery packs cool down. In this embodiment it may be possible to achieve longer runtimes for the measurement system downhole than if the batteries were purely sequentially depleted.

In an embodiment, the local controller configured in each respective battery pack can monitor power usage and energy consumption for that particular battery pack. In this embodiment, batteries that are deployed and brought uphole may be intelligently re-deployed based on remaining power available. This aspect of the invention, when configured in an embodiment, can enable more efficient use and less waste of battery packs at a given wellsite.

In another embodiment, the global power supply system controller or other similarly situated and capable controllers of the downhole assembly such as the main processing unit (“MPU”) could query the local battery controller network for local parameter statistics, such as those observed by monitoring battery voltage, power usage, uptime, temperature, current, and other parameters. In an embodiment, the global power supply system controller can query battery status parameters such as percentage of energy used or remaining and the power supply system could then interpret the queried parameter and determine whether to put a different battery onto the battery bus. In this embodiment, a global controller can utilize and take advantage of the ability to monitor battery statistics for individual batteries configured on the battery communication network. In an embodiment, the batteries themselves may have limited local storage capacity to store battery status parameters over time, in this embodiment the global power supply system controller can query the batteries regularly at a pre-determined time interval and store the returned status parameters. In this embodiment the status parameters would be collected and stored with identifiers to associate the status parameters with particular batteries, the time the status was collected may also be stored for later analysis. In an embodiment, the global power supply system controller or another configured controller as described above can compare and analyze the parameters recently read or previously collected and stored to determine which battery or batteries should be powering the measurement assembly. The global power supply system controller can then send communication messages over the battery communication network to tell individual batteries to power on and off. In an embodiment, recognizing that individual battery packs may have limited storage configured, the global power supply system controller can transfer parameter logs from the individual battery packs to its memory, which can free up local memory, to thereby allow for continued local logging of parameters. The global power supply system controller may also offload data from the individual battery packs in this manner to then process or compare the information from the individual battery packs.

In an embodiment, multiple batteries can be configured to be on and off at a given time. For example, it may be optimal for a downhole measurement assembly to have multiple batteries on during a certain time period when higher power output is needed or the system may simply be designed to use multiple batteries at once. In such an embodiment, the batteries would not necessarily need to be turned on and off in set groups but individual batteries may be turned on and off as needed. In this embodiment, the batteries can locally arbitrate or a global power supply system controller can arbitrate and control which batteries are turning on and off as was previously described.

In an embodiment, the local controller and any optionally configured connected components can power on and off at pre-determined intervals to minimize power consumption. In an embodiment, the local controllers can also be configured with a wake-up feature to determine when other batteries are communicating or attempting to communicate over the battery bus such that the local controller can power-up and power-up any needed components. In a downhole environment it may be necessary to conserve power as much as possible, thus the battery local controllers and corresponding components need not be powered on all the time, though they may be configured this way in certain configurations and/or downhole environments.

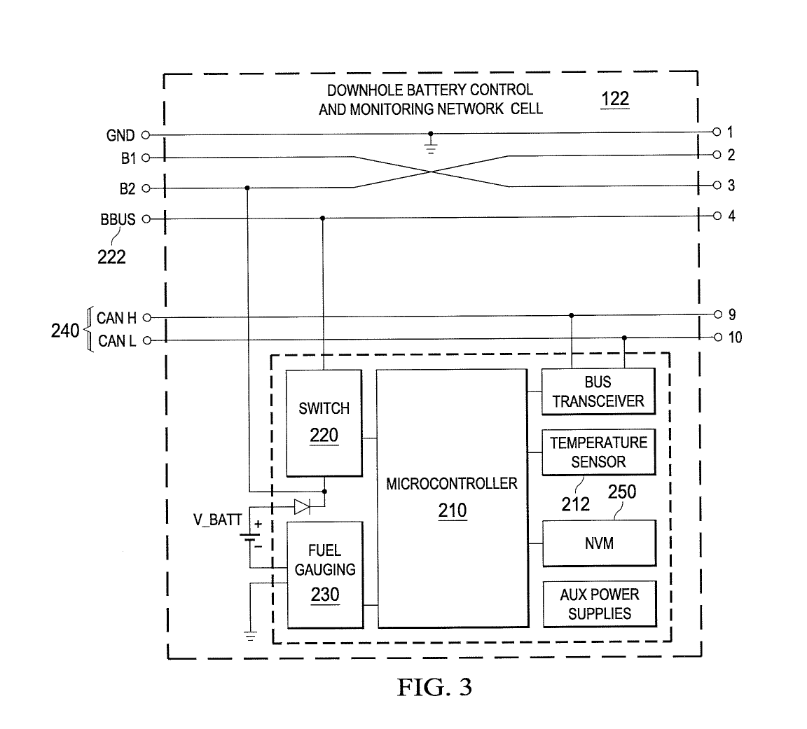

FIG. 3 shows a specific embodiment of a local battery controller assembly 122. In an embodiment, two or more downhole battery control and monitoring network cells are configured (though only one of the network cells is shown in FIG. 3) and can include: a microcontroller 210, temperature sensor 212, unique battery identification information configured along with the microcontroller or separate from the microcontroller, battery power on/off circuitry (“switch” as shown in FIG. 3) 220, fuel gauging circuitry 230, network circuitry 240, and non-volatile memory 250. As can be appreciated, certain components of the local battery controller assembly 122 can be either included or removed for a given configuration of the downhole battery control and monitoring system. Generally, a microcontroller 210, a battery network communication section will be configured along with switch circuitry to power the battery on and off 220 with respect to the battery bus 222. Further, it should be appreciated that a configured microcontroller may be integrated with a network communication controller or other means to connect and communicate over the battery network. FIG. 3 illustrates an embodiment where the CAN bus network circuitry 240 is configured, though other networks may be substituted for the CAN bus network shown. For example, other multi-node serial buses can be configured such as RS 485 or qMIX bus. Further, in an embodiment, temperature sensors integrated with the microcontroller or other chips configured in the battery control and monitoring network cell can be monitored and/or logged. Additionally, in an embodiment, one or more separate temperature sensors can be deployed and configured within or near the battery pack and may be monitored and/or logged by the downhole battery control and monitoring network cell. In an alternate embodiment, another controller of the downhole assembly may monitor and log temperature and/or other parameters and associate those logged parameter values with a particular battery or battery pack. These logged parameters can also be processed and analyzed by the controller to compare the behavior of the batteries and make efficiency and optimization determinations about which batteries to drain at what time intervals to achieve the longest duration of battery life for a given tool configuration and environment.

As shown in FIG. 3, and as configured in this embodiment, Lines 1 and 4-10 are pass-through lines, while Lines 2 and 3 cross. These lines are the battery power connection lines typically configured in a traditional Tensor-style MWD system where two battery packs are configured. In the traditional configuration these packs are connected to a power supply module which can switch battery 2 onto the battery bus after battery 1 has been depleted. The power supply switching in these systems is usually controlled by the main processing unit (MPU) of the tool. To simplify things, in such a configuration both battery 1 and 2 are typically wired the same way, their physical position in the system determines their order of depletion. The cells of the battery are connected to line 2 (battery 2) on the down-hole end of the pack, while line 2 on the up-hole end of the battery pack crosses to line 1 on the down-hole end. By keeping this configuration, compatibility is maintained with older systems that may not have a main processing unit that is capable of communication with the battery packs. It should also be noted that in an embodiment of the present invention the batteries are configured such that their internal switches that would switch their cells onto the battery bus, are off by default. In such a case, the MPU, power supply controller, individual battery controller, or other configured controller, will take care of battery depletion sequencing, depending on the configuration in a particular embodiment. In an alternative embodiment, multiple controllers configured in the downhole assembly may share the burden of analyzing battery parameters and making determination decisions about the most efficient and/or optimal way to deplete the batteries in a particular downhole environment. In the embodiment illustrated in FIG. 3, the battery negative terminal is connected to the board negative power input, where it passes through a coulomb counter that can be configured (as part of the battery fuel gauging circuitry) and back to ground and the positive terminal of the battery is connected to the board positive power input terminal. The coulomb counter values can be stored to memory or further processed by the microcontroller of the network cell to determine battery charge state. Additionally, other methods can be employed by the network cell to measure and determine battery charge state. For example, battery voltage measurements can be taken at regular intervals. These measurements can be logged, measured, and compared against pre-determined values (by the microcontroller of the network cell). Continuing to follow the battery bus pathway of the described embodiment, from here, the power output path splits into two. The first path is through a diode back out of the board to the Batt 2 line of the battery pack. The second path is through a MOSFET switch (which is configured to be off by default in this embodiment), and then from the board, it is connected to the battery bus (Batt Bus) line of the battery pack, which can be configured as the power line from which all of the tool components draw power. In this embodiment, Lines 9 and 10 are the CAN bus lines, CANH and CANL, respectively which connect to the microcontroller on the board through a transceiver chip, or directly to the microcontroller when then particular microcontroller configured contains integrated CAN bus circuitry. As has been described, CAN or other communication networks may be set up on the bus to provide a communications channel between the respective batteries of the downhole measurement system. In an embodiment, the batteries will remain compatible with and can be configured in stacked configurations, such as is possible in Tensor-style MWD tools. Additionally, in an embodiment, each battery pack will have the ability to switch its cells onto the battery bus. In the described embodiment, the protection diodes for the cell have been integrated into the board which maintains compatibility with Tensor-style tools. These diodes as configured protect the cell from reverse current, while keeping the diode drops as low as possible.

In an embodiment, a local battery controller assembly can be configured with an auxiliary power supply. In this embodiment, such a supply would typically be connected after the diode and in parallel with B2 and the switch for BBUS, though it may be connected in a different manner. Further, in an embodiment this supply can be hard wired to be constantly supplying power to the local battery controller assembly.

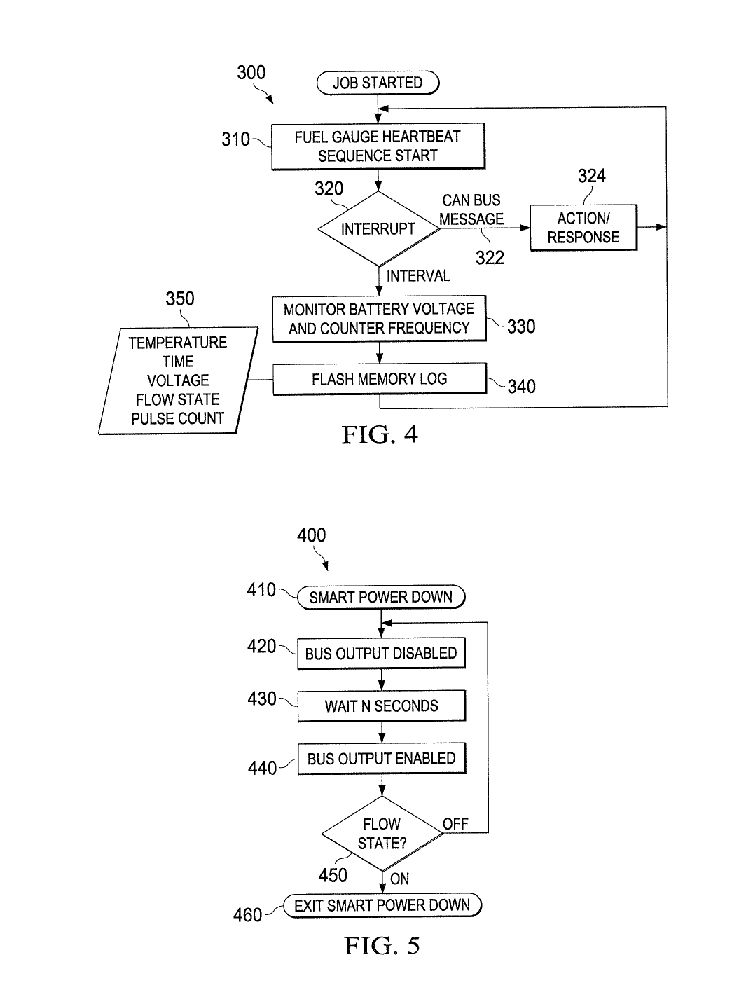

FIG. 4 is an example flow chart of a job start sequence 300 for an embodiment of the downhole battery control and monitoring system and assembly. In this embodiment, once a job is started a fuel gauge heart beat sequence is started or initiated 310. As part of this sequence the fuel gauging circuitry of the downhole battery control and monitoring network cell (as shown and described in reference to FIG. 3) performs measurements on an interval to determine the charge state of any batteries configured as part of the downhole battery control and monitoring network cell. In an embodiment, the desired logging interval may vary based on operating conditions and thus may be programmed to suit a specific situation. For example, it may be useful to log at an increased interval as the battery approaches end of life. In an embodiment, a battery near end of life can be configured to send out warning messages over the configured network. These messages can be directed to or received by other components on the bus. In an embodiment, depending on the message, components can be directed to or otherwise caused to enter a low power state based on the warning. A few examples of a component entering a low power state can include: a measurement component reducing the interval on which measurements are taken, and/or increasing the interval on which measurements are reported to the surface but making the measurements themselves farther apart to reduce overall power consumption. This can have the added benefit of achieving additional measurements using a battery that is nearing end of life and would otherwise have already needed to be pulled and replaced to continue taking measurements. Avoiding or reducing overall tool string downtime by increasing the time that individual battery packs can be deployed downhole is also a benefit of many of the described embodiments. The microcontroller portion of the network cell can then log the measurements to memory, average the measurements with previous measurements or otherwise perform a calculation to determine if the battery charge has fallen below a pre-determined level upon which it may be desirable to switch to another battery pack of the system. In an embodiment, a microcontroller or processor of the network cell may enter a sleep or reduced power consumption state. When in this state, some logic remains functioning such that the network cell's microcontroller can wake up and respond to interrupts 320 that may be triggered for a variety of conditions. Typically the interrupts will be triggered by an action such as a network message, a CAN bus message 322 for example, a coulomb counter interrupt, or another alarm or event. For example, a temperature sensor may be configured to trigger an interrupt line to the microcontroller on pre-determined actionable or near actionable temperature levels. In an alternate embodiment, an interrupt may be configured to occur at a pre-determined time interval to thereby initiate battery monitoring and/or the logging of various parameters by the network cell of the battery pack. For example, and as illustrated in FIG. 4, after an interrupt, battery voltage and coulomb counter frequency may be measured 330. Alternatively the coulomb counter signal may itself be used as an interrupt source used to measure the energy depleted from the battery cells. In this embodiment, the coulomb counter integrates the instantaneous current leaving the battery cells. Once a preset threshold is reached, an interrupt is generated to the microcontroller and the integral sum is cleared to zero. This can provide an interrupt, for example, once for each amp-second that leaves the cells. Each battery has a certain number of amp-seconds contained in the cells and therefore, a somewhat predetermined number of interrupts that will be generated over the life of the cells. Since a coulomb is equal to one amp-second, a coulomb counter counts how many amp-seconds or fractions thereof have passed through it. In an embodiment, an additional step may include logging various values to flash memory 340 configured as part of the battery pack network cell. For example, temperature, time, voltage, flow state, pulse count, and energy depleted may all optionally be logged 350. In a preferred embodiment the logging routine may be initiated at one second intervals to thereby provide a one second level of resolution to the parameters log, though other intervals may also be configured. As an additional and alternate step, processes may also be kicked off at pre-defined time intervals to analyze the values of the logged parameters. Based on the analysis, the microcontroller can be configured to carry out specific tasks. For example, if voltage begins to drop, it may be an appropriate time to switch to another battery configured as part of the downhole battery control and monitoring system. A battery switching sequence can then be initiated whereby another configured network cell switches the connection to the battery bus ‘ON.’ The prior ‘ON’ network cell can then switch the connection between its batteries and the battery bus to the ‘OFF’ state.

FIG. 5 refers to an example smart power down sequence 400 for a given battery that is optionally configured in a downhole battery control and monitoring system. The purpose of this sequence is to save battery power for when it is needed. For example, when an installed system is being shipped to an onsite location and the batteries are plugged in but not desired to be used yet, this state will preserve battery power until needed. This state can also be useful when battery packs are deployed downhole but not yet in use. In the illustrated embodiment, smart power down is initiated 410, power bus output is disabled 420, a pre-determined wait period occurs 430, and then bus output is re-enabled 440. Flow state is then determined 450. If flow state is determined to be active, then smart power down can be exited and regular operation can commence. If flow state is determined to be inactive, the sequence will repeat until flow state is active, thereby preserving battery energy until needed. This can be beneficial as tools are often assembled with the battery packs plugged in and tool components already using battery power before the tool is deployed downhole. For example, a tool may be plugged in, tested, and ready for deployment but may then sit in a warehouse or in a truck during shipment, and then may spend even more time waiting on-site before it is deployed downhole. By cycling through periods where the power bus output is disabled, shelf-life and ultimately deployed tool life can be increased. In an alternate embodiment, instead of monitoring flow state to determine when to exit the smart power-down sequence, the processor can monitor other sensors. For example, a vibration sensor or pressure sensor can be monitored to determine when to exit the smart power-down sequence and commence with active tool operation. The wait period between cycles can also be configured. For example, in an embodiment, a wait period of 30 seconds might be used. With this interval the tool may be effectively on for around 10% of the time when not in active use. Other longer intervals can be configured and optimal wake-up routines can be run to further reduce power usage during this stage. In an embodiment, a tool can be configured to re-enter the smart power-down sequence when the tool has been deployed but is idle or when the tool is temporarily pulled such that the active tool operation state is not desired.

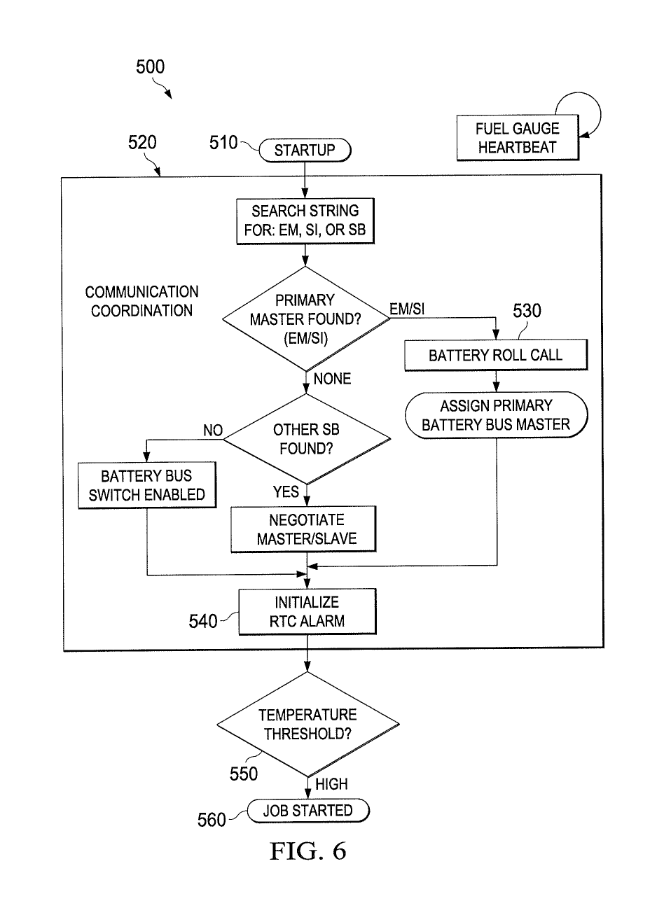

FIG. 6 is a flow chart showing an example coordination algorithm of a downhole battery control and monitoring system 500. Once startup 510 occurs the network cells of each battery pack can initiate communication coordination protocols 520 to determine if a primary master network cell has already been assigned or if arbitration to determine a primary master network cell (and associated battery or batteries) needs to be performed. Further, in an embodiment, a battery roll call sequence 530 can also be initiated 540 to determine the existence and/or availability of other network cells (and their associated batteries). Once the list of configured and available network cells has been determined and a master has been assigned, an RTC (real time clock) alarm can be initialized 540 and configured and a job can begin. In an embodiment the RTC alarms can be configured to cause interrupts that initiate parameter logging for battery pack network cells. Further, in an embodiment the RTC alarms can be configured to interrupt each network cell at the same or at different intervals. In an embodiment, temperature thresholds can also be checked 550 before job start is initiated 560. If temperatures are out of the desired range, job start may be delayed and/or errors may be propagated to the surface to indicate onsite personnel of the potential problem.

In an embodiment, the microcontroller can go in and out of a low power state and can be configured to wake up on a defined interval. During the wake-up cycle, pending tasks can be performed and the heartbeat information of the battery can be transmitted. The microcontroller can then return to the low power state.

In an embodiment, an analog continuous coulomb counter can be configured to monitor overall energy usage of a particular battery or battery pack. By employing an analog continuous-time coulomb counter accurate charge measurements can be made, and in turn, accurate predictions can be made about how long a battery will last and when the battery is approaching end of life. In an alternate embodiment a digital coulomb counter can be configured.

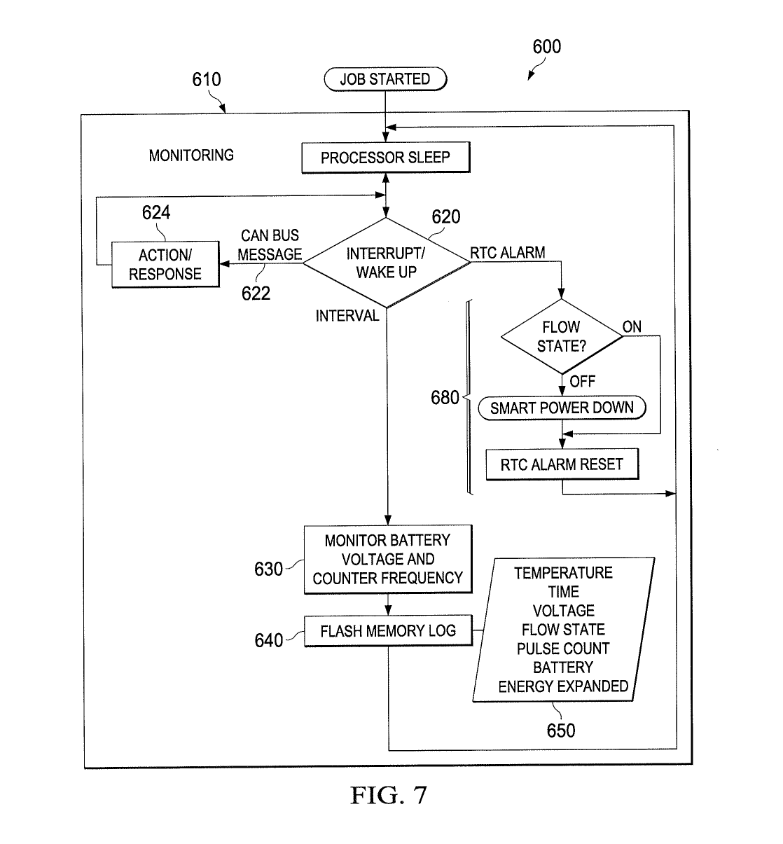

FIG. 7 is a flow chart showing an example monitoring algorithm for a downhole battery control and monitoring system 600, configured with elements previously described in relation to FIGS. 4-6. In an embodiment the above-described coordination algorithm, once complete, may initiate the monitoring algorithm as described below and as shown in FIG. 7. In this algorithm the processor or microcontroller may initially be in a sleep state to conserve power. Once the interrupt state occurs (as was similarly described above and in relation to FIG. 4) battery measurement and the logging of various parameters may occur (collectively “Monitoring”) 610. Further, in an embodiment, flow state can be monitored and a sequence can be initiated where battery power is suspended over pre-determined time intervals until flow state resumes 680. Further, in an embodiment a RTC (real time clock) interval alarm may configured on flow stop such that each time the alarm triggers, battery power is re-initiated to allow flow to be checked again. Once flow resumes, battery power will remain on when needed or configured to be on. This reduction in battery usage at flow stop allows for battery power savings and cost savings by extending useful battery life. An example algorithm for a smart power down sequence for is described above in relation to FIG. 5. Further, FIG. 7 illustrates an embodiment where the fuel gauge heartbeat sequence is included. In this embodiment the monitoring 610 routine includes an interrupt or interval wakeup check 620. When a flow state interrupt occurs the flow state check routine is initiated 680. If an interval interrupt occurs, voltage and coulomb counts are performed 630 and various parameters 650 can be logged 640. A CAN bus message 632 can also cause an action 624 in response to that message.

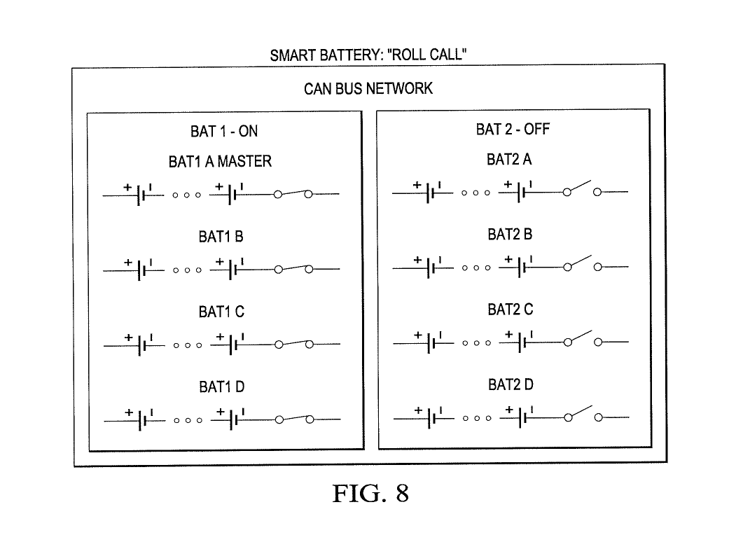

FIG. 8 illustrates a potential logical battery configuration as would be determined by the battery roll call sequence described in relation to the example coordination algorithm shown in and described in relation to FIG. 6.

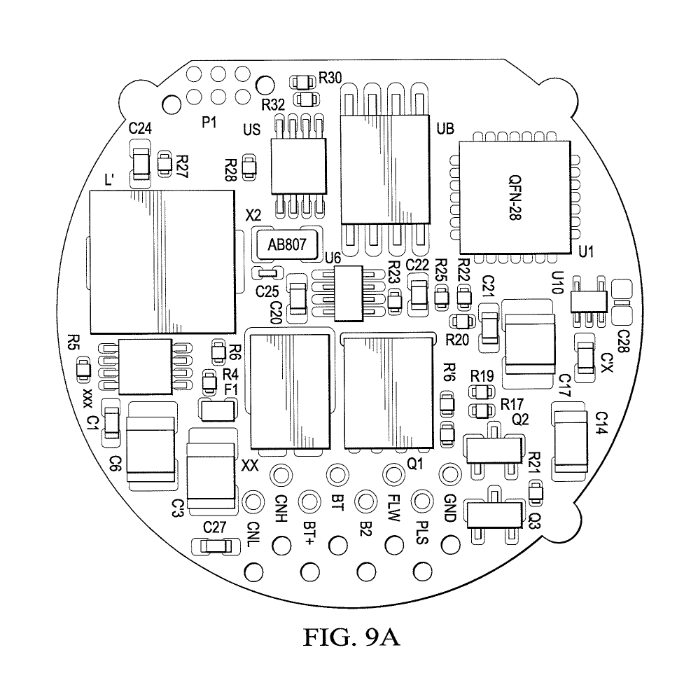

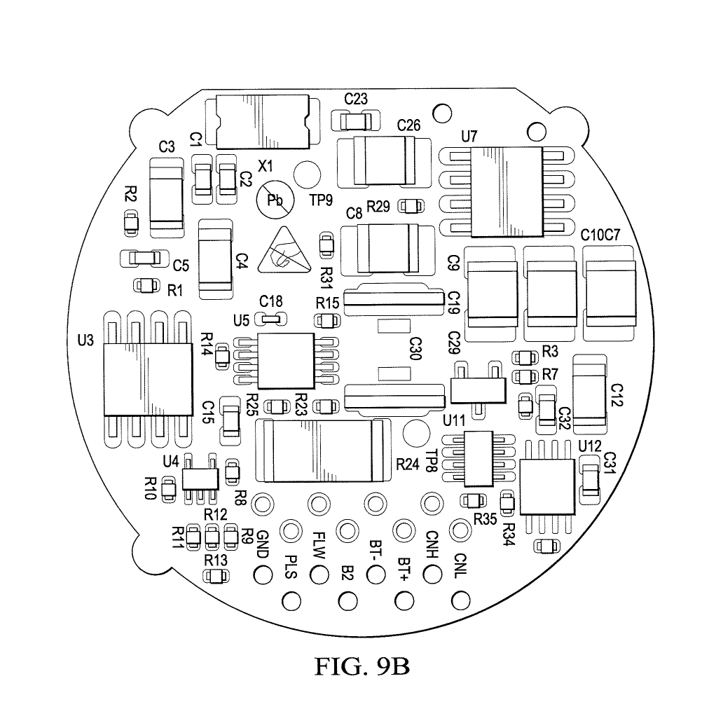

FIGS. 9A and 9B illustrate an example embodiment of a circuit board layout for an individual battery pack of a downhole battery control and monitoring system. The components configured in this example embodiment include: a processor (or microcontroller), a real time clock, flash memory, a coulomb counter, a temperature sensor, battery voltage measurement circuitry, a battery output switch, an auxiliary power supply, and a CAN bus transceiver module and circuitry. In an embodiment, the listed components can each be optionally configured, and multiples of some components may be configured as desired. For example, it may be desirable to configure multiple temperature sensors to detect temperatures both on the circuit board and at or near the batteries of a particular unit. As one familiar in the art would appreciate, a variety of configurations can be developed to suit given job environments and parameters.

In an embodiment, safety features can be configured as part of a downhole battery control and monitoring system. For example, when battery voltage gets too low for the types of batteries typically used in a particular application, if the batteries see continued use they can become volatile and shocks or other movements can cause the batteries to explode. In a system where the usage is being monitored or otherwise tracked, the battery bus can be shut off by the control and monitoring system prior to the battery becoming volatile. In an embodiment, a shock sensor can be utilized to track the shocks to which a battery is subjected. The sensor can also be utilized to turn the battery bus on and off in the event of high shock events. In an embodiment, the shock sensor can also be used by the control and monitoring system as part of the smart power-down and wake-up routines to determine whether the tool has been deployed or not.

Although the concepts disclosed herein have been described in connection with the preferred form of practicing them and modifications thereto, those of ordinary skill in the art will understand that many other modifications can be made thereto. Accordingly, it is not intended that the scope of these concepts in any way be limited by the above description.

1. A downhole measurement assembly comprising:
a battery bus,
a battery communication network,
two or more battery packs configured on a tubing string, each of the battery packs further comprising:
one or more batteries,
one or more switched connections between the one or more batteries and the battery bus,
one or more sets of battery control circuitry configured to control when the one or more battery packs provides power to the battery bus,
one or more battery pack microcontrollers, connected to and configured to control the one or more sets of battery control circuitry,
one or more network elements, configured such that at least one of the one or more battery pack microcontrollers can communicate with at least one of the battery pack microcontrollers of another battery pack across the battery communication network,
one or more memory elements.

2. The downhole measurement assembly of claim 1, wherein at least one of the one or more battery pack microcontrollers is further configured to monitor energy consumption of at least one of the one or more batteries.

3. The downhole measurement assembly of claim 2, wherein at least one of the one or more battery pack microcontrollers is configured to determine what portion of at least one of the battery packs has been depleted.

4. The downhole measurement assembly of claim 3, wherein at least one of the one or more battery pack microcontrollers is configured to communicate with at least one of the other of the one or more battery packs over the battery communication network to instruct one of the other one or more battery packs to provide power to the battery bus.

5. The downhole measurement assembly of claim 2, wherein at least one of the one or more battery pack microcontrollers is configured to determine when at least one of the one or more battery packs has malfunctioned.

6. The downhole measurement assembly of claim 5, wherein at least one of the one or more battery pack microcontrollers is configured to communicate with at least one of the other of the one or more battery packs over the battery communication network to instruct one of the other one or more battery packs to provide power to the battery bus.

7. The downhole measurement assembly of claim 1 further comprising one or more activity sensors configured to detect when the downhole measurement assembly is or is not in active use.

8. The downhole measurement assembly of claim 7, wherein at least one of the one or more battery pack microcontrollers is configured to execute a power down sequence that temporarily disconnects power between at least one of the one or more batteries and the battery bus when at least one of the one or more activity sensors indicates the assembly is not in active use.

9. The downhole measurement assembly of claim 8, wherein at least one of the one or more activity sensors is a flow state sensor.

10. The downhole measurement assembly of claim 8, wherein at least one of the one or more activity sensors is a vibration sensor.

11. The downhole measurement assembly of claim 8, wherein at least one of the one or more activity sensors is a pressure sensor.

12. A downhole measurement assembly comprising:
a battery bus,
a battery communication network.
two or more battery packs configured on a tubing string, each of the battery packs further comprising:
one or more batteries,
one or more switched connections between the one or more batteries and the battery bus,
one or more sets of battery control circuitry configured to control when the one or more battery packs provides power to the battery bus,
one or more coulomb counters, configured to measure battery pack power output,
one or more battery pack microcontrollers, connected to and configured to control the one or more sets of battery control circuitry,
one or more network elements, configured such that at least one of the one or more battery pack microcontrollers can communicate with at least one of the battery pack microcontrollers of another battery pack across the battery communication network,
non-transitory computer readable storage medium in communication with the one or more battery pack microcontrollers with an executable program stored thereon, the executable program comprising a set of instructions that, when executed by the one or more microcontrollers, causes the one or more microcontrollers to perform the operations of:
receiving readings from the coulomb counter,
comparing said readings to estimated battery life measurement values,
using said comparison to determine when one of the battery packs has reached a predetermined point of depletion, and
issuing a command to the battery bus to cause another of the battery packs to output power on the battery bus.

13. The downhole measurement assembly of claim 12, further comprising one or more activity sensors configured to detect when the downhole measurement assembly is not in active use.

14. The downhole measurement assembly of claim 13, wherein at least one of the one or more battery pack microcontrollers is configured to execute a power down sequence that temporarily disconnects power between at least one of the battery packs and the battery bus when at least one of the one or more activity sensors indicates the assembly is not in active use.

15. The downhole measurement assembly of claim 14, wherein at least one of the one or more activity sensors is a flow state sensor.

16. The downhole measurement assembly of claim 14, wherein at least one of the one or more activity sensors is a vibration sensor.

17. The downhole measurement assembly of claim 14, wherein at least one of the one or more activity sensors is a pressure sensor.

18. A method of facilitating reliable and efficient battery consumption of a downhole measurement, the method comprising the following steps:
receiving readings from a coulomb counter connected to, and taking measurements of output from, at least one battery pack of two or more battery packs configured to output power on a battery bus as part of a downhole measurement assembly,
comparing said readings to estimated battery life measurement values,
using said comparison to determine when one of the battery packs has reached a predetermined point of depletion, and
issuing a command to the battery bus to cause another of the downhole battery packs to output power on the battery bus.

19. The method of claim 18, further comprising the step of receiving readings from one or more activity sensors configured to detect when the downhole measurement assembly is not in active use.

20. The method of claim 19, further comprising the step of executing a power down sequence that temporarily disconnects power for pre-configured intervals between at least one of the battery packs and the battery bus when at least one of the one or more activity sensors indicates the assembly is not in active use.

21. The method of claim 20, further comprising the step of halting the power down sequence when at least one of the one or more activity sensors indicates the assembly is in active use.

22. The method of claim 18, further comprising the step of communicating to a remote computer on the surface when one of the battery packs has reached a predetermined point of depletion.

23. The method of claim 22, further comprising the step of communicating to a remote computer on the surface when each of the battery packs has reached a predetermined point of depletion.
